(19) United States
(12) Patent Application Publication
(10) Pub. No.: US 2021/0010724 A1
(43) Pub. Date: Jan. 14, 2021

(54) MAGNETIC WORK BODY UNIT AND MAGNETIC HEAT PUMP DEVICE USING SAME

(71) Applicant: SANDEN HOLDINGS CORPORATION, Isesaki-shi, Gunma (JP)

(72) Inventors: Makoto TAKEDA, Isesaki-shi, Gunma (JP); Takaaki UNO, Isesaki-shi, Gunma (JP); Sangchul BAE, Isesaki-shi, Gunma (JP); Yusuke YAMAGUCHI, Isesaki-shi, Gunma (JP)

(21) Appl. No.: 16/493,570

(22) PCT Filed: Feb. 13, 2018
(86) PCT No.: PCT/JP2018/004813

§ 371 Date: Sep. 12, 2019

(30) Foreign Application Priority Data
Mar. 13, 2017 (JP) 2017-047422

(51) Int. Cl. F25B 30/06; F25B 21/00

(52) U.S. Cl. CPC F25B 30/06; F25B 21/00

(57) ABSTRACT

There are provided a magnetic work body unit in which plate-shaped magnetic work bodies can be easily laminated and a magnetic heat pump device using the same. Magnetic work body units 26A to 26D are provided with a plurality of plate-shaped magnetic work bodies 28 laminated in a zigzag shape as viewed in the flowing direction of a heat medium between the facing inner surfaces of rectangular ducts 27A to 27D forming flow passages through which the heat medium passes. A magnetic heat pump device is configured by alternately performing magnetization and demagnetization of the magnetic work body units 26A to 26D.

### TECHNICAL FIELD

The present invention relates to a plate-shaped magnetic work body unit having a magnetocaloric effect and a magnetic heat pump device using the same.

### BACKGROUND ART

In place of a conventional vapor compression refrigerator using a gas medium, such as chlorofluorocarbon, a magnetic heat pump device utilizing a magnetocaloric effect which is a property that a magnetic work substance causes a large temperature change in magnetization and demagnetization has recently drawn attention.

The magnetic heat pump device is configured so that the magnetic work substance is disposed in a liquid medium flow passage to exchange heat with a heat medium by the magnetocaloric effect. Conventionally, the magnetic work substance is molded into a granular shape, the granular-shaped magnetic work substances are stored in a tubular case, and a liquid medium is circulated in the tubular case.

Thus, when the magnetic work substance is molded into a granular shape, while the contact surface area with the liquid medium can be increased, the flow passage resistance of the heat medium increases, which has posed a problem that efficient heat exchange cannot be performed.

Therefore, in order to reduce the flow passage resistance of the heat medium, magnetic work bodies described in PTLS 1 and 2 have been proposed.

In PTL 1, two modules in which a large number of blades are aligned in a comb shape in the cross section of a magnetic work substance are alternately combined so that the blades of one module are inserted between the blades of the other module, and a heat medium is passed through gaps formed between the blades.

In PTL 2, a thin band body is formed by a melt quenching method using a powder raw material, four thin band bodies are laminated to form a plate-shaped laminate, the laminate is cut, ground, polished, and the like to produce a material piece in which a groove extending in a depth direction with a 0.1 mm depth is formed in the main surface, the material pieces are heated, and then the material pieces which are made to absorb hydrogen are laminated to manufacture a heat exchanger serving as a microchannel.

### CITATION LIST

### Patent Literature

PTL 1: JP 2015-524908 T

PTL 2: JP 2014-44003 A

### SUMMARY OF INVENTION

### Technical Problem

However, the conventional example described in PTL 1 described above has an unsolved problem that the two kinds of modules having the plurality of two kinds of blades are integrally molded by extrusion molding, and therefore, when the number, thickness, and the like of the blades are changed, extrusion molding dies need to be formed one by one, so that modules having an arbitrary number of blades cannot be easily formed at a low cost.

The conventional example described in PTL 2 described above has unsolved problems that the four thin band bodies are laminated to form the laminate, the laminate is cut, ground, polished, and the like while leaving both the side surface sides to form a material piece in which the groove serving as a heat medium flow passage is formed, and then the material pieces are laminated to thereby manufacture the heat exchanger serving as a microchannel, and therefore the manufacturing process becomes complicated and the material pieces cannot be easily formed because machining, such as cutting, grinding, and polishing, is involved.

Thus, the present invention has been made focusing on the unsolved problems of the conventional examples described in PTLS 1 and 2 described above. It is an object of the present invention to provide a magnetic work body unit in which plate-shaped bodies formed of a magnetic work substance can be easily laminated with space therebetween and a magnetic heat pump device using the same.

### Solution to Problem

In order to achieve the above-described object, in one aspect of a magnetic work body unit according to the present invention, a plurality of plate-shaped bodies formed of a magnetic work substance longer than the distance between the facing inner surfaces of a rectangular duct forming flow passages through which a heat medium passes are laminated in a zigzag shape as viewed in the flowing direction of the heat medium between the facing inner surfaces.

One aspect of a magnetic heat pump device according to the present invention is provided with the above-described magnetic work body unit in which a heat medium is made to flow, a magnetic field changing mechanism configured to change the magnitude of a magnetic field applied to a magnetic work body of the magnetic work body unit, a heat medium moving mechanism configured to move the heat medium between a high temperature end and a low temperature end of the magnetic work body unit, a heat dissipation side heat exchanger configured to cause the heat medium on the high temperature end side to dissipate heat, and a heat absorption side heat exchanger configured to cause the heat medium on the low temperature end side to absorb heat.

### Advantageous Effects of Invention

According to one aspect of the present invention, the magnetic work body unit provided with the heat medium flow passages can be easily formed by laminating the plurality of plate-shaped bodies formed of the magnetic work substance in the zig zag shape as viewed in the heat medium flowing direction in the rectangular ducts.

Moreover, the magnetic heat pump device of a simple configuration can be easily created by incorporating the magnetic work body unit having the above-described configuration.

### BRIEF DESCRIPTION OF DRAWINGS

FIG. 1 is a schematic block diagram illustrating one embodiment of a magnetic heat pump device according to the present invention;

FIG. 2 is a cross-sectional view illustrating a heat pump body of FIG. 1;

FIG. 3 is a cross-sectional view illustrating a magnetic work body unit of FIG. 1;

FIG. 4 is a perspective view illustrating a plate-shaped magnetic work body of FIG. 3;

FIG. 5 is a characteristic diagram illustrating the relationship between the temperature of a magnetic work substance and an entropy change;

FIG. 6 is a characteristic diagram illustrating the temperatures of a high temperature end and a low temperature end of the magnetic work body in a state where a temperature change is saturated;

FIG. 7 is a perspective view illustrating a second embodiment of the magnetic work body unit according to the present invention;

FIG. 8 is a perspective view illustrating the plate-shaped magnetic work body of FIG. 7;

FIG. 9 is a cross-sectional view illustrating a modification of the plate-shaped magnetic work body; and

FIG. 10 is a perspective view illustrating a modification of the heat pump body.

### DESCRIPTION OF EMBODIMENTS

Next, one embodiment of the present invention is described with reference to the drawings. In the following description of the drawings, the same or similar portions are designated by the same or similar reference numerals. However, it should be noted that the drawings are schematic and the relationship between the thickness and the plane dimension, the ratio in thickness of each layer, and the like are different from actual relationship, ratio, and the like. Therefore, specific thickness and dimension should be determined considering the following description. It is a matter of course that the drawings also include portions having dimensional relationships and ratios different from each other.

Moreover, the embodiments described below illustrate devices or methods for embodying the technological idea of the present invention and the technological idea of the present invention does not specify materials, shapes, structures, arrangement, and the like of constituent components to the materials, shapes, structures, arrangement, and the like described below. The technological idea of the present invention can be variously altered in the technological scope specified by Claims described in Claims.

### First Embodiment

First, one embodiment of a magnetic heat pump device illustrating a first aspect of the present invention is described.

### [Configuration of Magnetic Heat Pump Device]

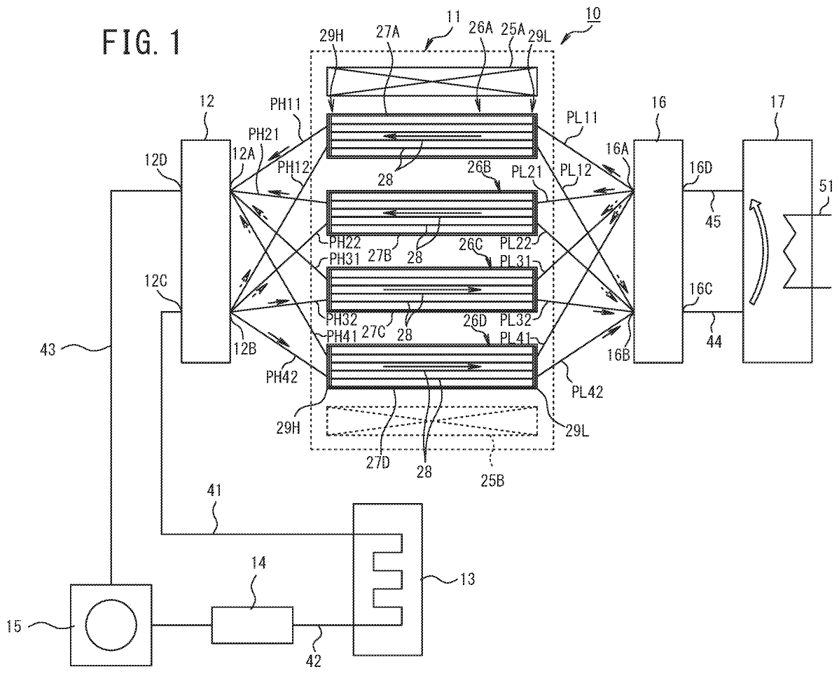

A magnetic heat pump device 10 is provided with a heat pump body 11, a high temperature side switching valve 12, a heat dissipation side heat exchanger 13, a heater 14, a circulating pump 15, a low temperature side switching valve 16, and a heat absorption side heat exchanger 17 as illustrated in FIG. 1.

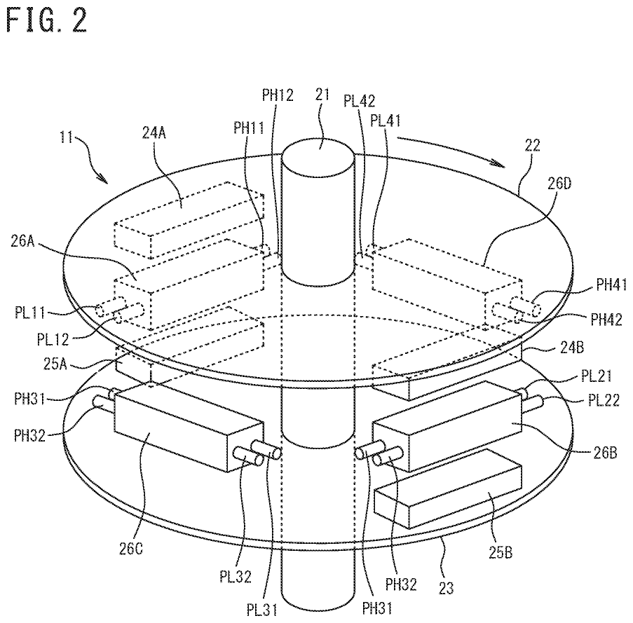

The heat pump body 11 configures a heat pump AMR (Active Magnetic Regenerator). The heat pump body 11 is provided with a rotation shaft 21 coupled to a servomotor which is not illustrated through a decelerator and rotationally driven in one direction and a pair of upper and lower supporting disks 22 and 23 of a magnetic yoke fixed to the rotation shaft 21 with a predetermined interval as illustrated in FIG. 2.

On the surface facing the supporting disk 23 of the supporting disk 22, rectangular parallelepiped-shaped permanent magnets 24A and 24B are disposed extending in the tangential direction at 180° intervals on the outer peripheral edge side. Similarly, on the surface facing the supporting disk 22 of the supporting disk 23, rectangular parallelepiped-shaped permanent magnets 25A and 25B are disposed to face the permanent magnets 24A and 24B, respectively.

Herein, in the permanent magnet 24A, the supporting disk 22 side is magnetized to the S pole, for example, and the surface facing the permanent magnet 25A is magnetized to the N pole. The permanent magnet 24B is magnetized so that the supporting disk 22 side is the N pole and the surface facing the permanent magnet 25B is the S pole. The permanent magnet 25A is magnetized so that the surface facing the permanent magnet 24A is the S pole and the supporting disk 23 side is the N pole. The permanent magnet 25B is magnetized so that the surface facing the permanent magnet 24B is the N pole and the supporting disk 23 side is the S pole.

Therefore, a magnetic path of the N pole of the permanent magnet 24A→the S pole of the permanent magnet 25A→the supporting disk 23→the S pole and the N pole of the permanent magnet 25B→the S pole and the N pole of the permanent magnet 24B→the supporting disk 22→the S pole of the permanent magnet 24A is formed.

Between the supporting disks 22 and 23, four magnetic work body units 26A and 26B and 26C and 26D in total are fixed and disposed at 0° and 180° positions and at 90° and 270° positions in the counterclockwise direction in the circumferential direction between the rotation track of the permanent magnets 24A and 24B and the rotation track of the permanent magnets 25A and 25B. With respect to the magnetic work body units 26A to 26D, when the magnetic work body units 26A and 26B are in a magnetized state, for example, in which the magnetic work body unit 26A faces the permanent magnets 24A and 25A (or 24B and 25B) and the magnetic work body unit 26B faces the permanent magnets 24B and 25B (or 24A and 25A), the magnetic work body units 26C and 26D are in a demagnetized state of not facing the permanent magnets 24A, 24B and 25A, 25B.

The magnetic work body units 26A to 26D contain four rectangular ducts 27A to 27D having a hollow shape with a rectangular cross section, respectively, and a plurality of plate-shaped magnetic work bodies 28 laminated in a zig zag shape as viewed in the axial direction in the rectangular ducts 27A to 27D.

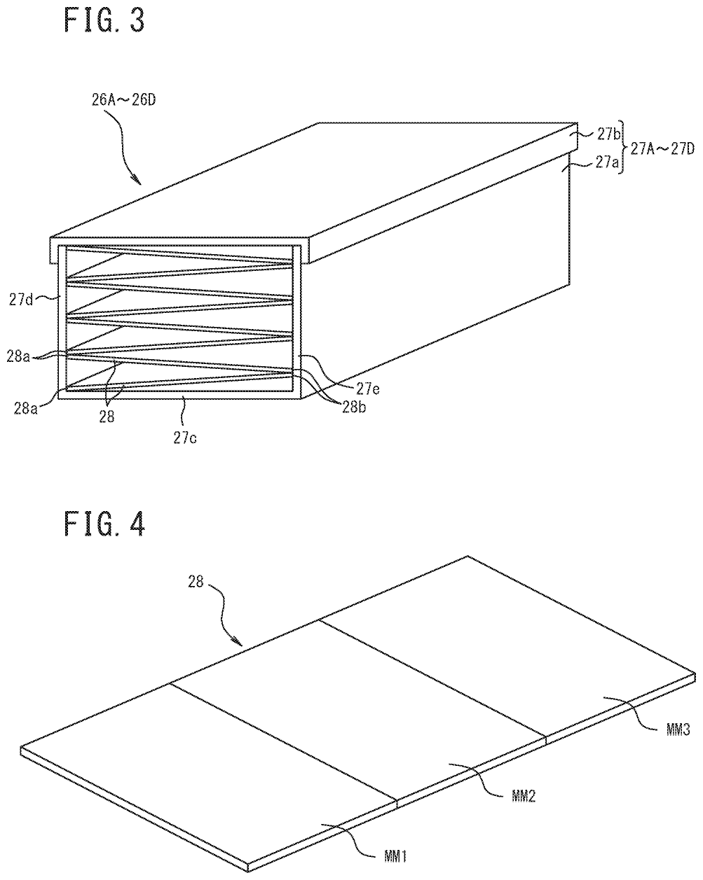

Each of the rectangular ducts 27A, 27B, 27C, and 27D is formed of a high heat insulating resin material. This reduces heat loss to the outside of the plate-shaped magnetic work body having a magnetocaloric effect described later and prevents heat transfer in the longitudinal direction. Each of the rectangular ducts 27A to 27D contains a bottomed square tubular portion 27a, the upper end of which is opened, and a lid portion 27b closing the upper end of the bottomed square tubular portion 27a as illustrated in FIG. 3. The length and the width of each of the rectangular ducts 27A to 27D are set to be equal to the length and the width of the permanent magnets 24A, 24B and 25A, 25B but the length and the width thereof do not necessarily need to equalize.

To a high temperature end 29H in the longitudinal direction of the rectangular duct 27A, two high temperature side pipes PH11 and PH12 through which a heat medium containing water, for example, passes are coupled. To a low temperature end 29L in the longitudinal direction, two low temperature side pipes PL11 and PL12 through which a heat medium containing water, for example, passes are coupled.

To a high temperature end 29H in the longitudinal direction of the rectangular duct 27B, two high temperature side pipes PH21 and PH22 through which a heat medium containing water, for example, passes are coupled. To a low temperature end 29L in the longitudinal direction, two low temperature side pipes PL21 and PL22 through which a heat medium containing water, for example, passes are coupled.

To a high temperature end 29H in the longitudinal direction of the rectangular duct 27C, two high temperature side pipes PH31 and PH32 through which a heat medium containing water, for example, passes are coupled. To a low temperature end 29L in the longitudinal direction, two low temperature side pipes PL31 and PL32 through which a heat medium containing water, for example, passes are coupled.

To a high temperature end 29H in the longitudinal direction of the rectangular duct 27D, two high temperature side pipes PH41 and PH42 through which a heat medium containing water, for example, passes are coupled. To a low temperature end 29L in the longitudinal direction, two low temperature side pipes PL41 and PL42 through which a heat medium containing water, for example, passes are coupled.

The plurality of plate-shaped magnetic work bodies 28 is formed into a plate shape having a thickness of about 1 mm using a magnetic work substance exhibiting the magnetocaloric effect which is a property of causing a large temperature change in magnetization and demagnetization. In each of the plate-shaped magnetic work bodies 28, the length is set to be equal to the inner length of each of the rectangular ducts 27A to 27D and the width is set to be longer than the inner width of each of the rectangular ducts 27A to 27D. Therefore, when the plate-shaped magnetic work bodies 28 are disposed in each of the rectangular ducts 27A to 27D, the plate-shaped magnetic work bodies 28 are disposed in a state of being inclined downward to the right or to the left as viewed in the cross section in a state where both ends in the width direction of the plate-shaped magnetic work bodies 28 contact the inner surfaces of the rectangular ducts 27A to 27D.

In order to configure the magnetic work body units 26A to 26D, the rectangular duct 27A is described as a representative. First, a left end 28a in one width direction of the plate-shaped magnetic work body 28 is brought into contact with a lower left corner portion where a lower surface plate 27c and a left side surface plate 27d are joined to each other and a right end 28b in the width direction is brought into contact with a right side surface plate 27e of the rectangular duct 27A while maintaining the contact state as illustrated in FIG. 3 in a state where the lid portion 27b of the rectangular duct 27A is removed, for example.

At this time, the width of the plate-shaped magnetic work body 28 is set to be longer than the width between the inner surfaces of the left side surface plate 27d and the right side surface plate 27e of the rectangular duct 27A. Therefore, the plate-shaped magnetic work body 28 is disposed to be inclined upward to the right as viewed in FIG. 3 in the state where the right end 28b in the width direction of the plate-shaped magnetic work body 28 contacts the inner surface of the right side surface plate 27e.

Subsequently, in a state where a right end 28b in the width direction of the next plate-shaped magnetic work body 28 is brought into contact with the right end 28b of the already disposed plate-shaped magnetic work body 28 and the right side surface plate 27e of the rectangular duct 27A, a left end 28a is brought into contact with the left side surface plate 27d of the rectangular duct 27A. Thus, the plate-shaped magnetic work body 28 is disposed to be inclined upward to the left as viewed in FIG. 3. Therefore, an isosceles triangular heat medium passage is formed by the upper and lower two plate-shaped magnetic work bodies 28.

By successively repeating the above work, the plurality of plate-shaped magnetic work bodies 28 can be successively laminated in the zig zag shape in the rectangular duct 27A. When the plate-shaped magnetic work bodies 28 are laminated up to the upper end of the bottomed square tubular portion 27a of the rectangular duct 27A, an upper portion of the bottomed square tubular portion 27a is closed with the lid portion 27b, and then the lid portion 27b is fixed to the bottomed square tubular portion 27a, whereby the magnetic work body unit 26A can be configured.

At this time, it is not required to provide a member positioning the plate-shaped magnetic work bodies 28 in the rectangular duct 27A and the plate-shaped magnetic work bodies 28 may be simply successively laminated, and therefore the magnetic work body unit 26A can be created with ease and at a low production cost.

Moreover, the plate-shaped magnetic work body 31 is preferably configured by arranging two or more of the magnetic work substances, e.g., three magnetic work substances of a first magnetic work substance MM1, a second magnetic work substance MM2, and a third magnetic work substance MM3, different in a temperature zone where a high magnetocaloric effect is exhibited in the longitudinal direction so that the temperature zone becomes higher in order, for example, as illustrated in FIG. 4. As one example, those in which the relationships between a temperature T and an entropy change (−ΔS) [J/kg·K] are illustrated in FIG. 5 are selected as the three magnetic work substances MM1 to MM3.

More specifically, for the first magnetic work substance MM1, an Mn-based material or a La-based material having a chevron-shaped characteristic in which the entropy change (−ΔS) reaches the peak at a temperature Tp1 around the lowest Curie point as illustrated by a characteristic curve L1 of FIG. 5 is used. For the second magnetic work substance MM2, an Mn-based material or a La-based material having a chevron-shaped characteristic in which the entropy change (−ΔS) reaches the peak at a temperature Tp2 around the Curie point higher than that of the first magnetic work substance MM1 as illustrated by a characteristic curve L2 of FIG. 5 is used. For the third magnetic work substance MM3, an Mn-based material or a La-based material having a chevron-shaped characteristic in which the entropy change (−ΔS) reaches the peak at a temperature Tp3 around the Curie point higher than that of the second magnetic work substance MM2 is used.

The Mn-based material or the La-based material has a larger magnetic entropy change (−ΔS) by magnetization/demagnetization and also higher heat absorption/heat dissipation capacity as compared with those of a conventionally used Gd-based material. However, an operation temperature zone (driving temperature span) where the high magnetocaloric effect of each material is exhibited is narrower than that of the Gd-based material. Therefore, when used alone, the temperature cannot be changed from normal temperature to a required freezing/heat dissipation temperature (hot-water supply or the like).

Therefore, by disposing the first magnetic work substance MM1, the second magnetic work substance MM2, and the third magnetic work substance MM3 side by side in the longitudinal direction of the plate-shaped magnetic work body 28, a high magnetocaloric effect can be obtained in a required temperature range.

The plate-shaped magnetic work bodies 28 may be just laminated in the magnetic work body units 26A to 26D. However, when the plate-shaped magnetic work bodies 28 are surely fixed, end portions in the width direction of the plate-shaped magnetic work bodies 28 are joined to the right and left side surface plates 27d and 27e of the rectangular ducts 27A to 27D by a joining means, such as blazing.

The high temperature side switching valve 12 contains a rotary valve, an electromagnetic valve, a poppet valve, and the like, for example, and switched and controlled with the rotation of a rotor 21. The high temperature side switching valve 12 is provided with connection ports 12A and 12B connected to the rectangular ducts 27A to 27D, an outflow port 12C connected to an inlet of the heat dissipation side heat exchanger 13, and an inflow port 12D connected to a discharge side of the circulating pump 15. The high temperature side switching valve 12 is switched to a state of causing the connection port 12A to communicate with the outflow port 12C synchronizing with the rotation of the rotor 21 described above and causing the connection port 12B to communicate with the inflow port 12D and a state of causing the connection port 12A to communicate with the inflow port 12D and causing the connection port 12B to communicate with the outflow port 12C.

To the connection port 12A, the high temperature side pipes PH11 to PH41 drawn out from the heat pump body 11 are connected. To the connection port 12B, the high temperature side pipes PH12 to PH42 drawn out from the heat pump body 11 are connected.

The outflow port 12C of the high temperature side switching valve 12 is connected to the inlet of the heat dissipation side heat exchanger 13 through a pipe 41 and an outlet of the heat dissipation side heat exchanger 13 is connected to the suction side of the circulating pump 15 through a pipe 42 and the heater 14 disposed in the middle of the pipe 42. The discharge side of the circulating pump 15 is connected to the inflow port 12D of the high temperature side switching valve 12 through a pipe 43, so that a circulation path on the heat dissipation side is configured.

The low temperature side switching valve 16 contains a rotary valve, an electromagnetic valve, a poppet valve, and the like, for example, and switched and controlled with the rotation of the rotor 21 as with the high temperature side switching valve 12 described above. The low temperature side switching valve 16 is provided with connection ports 16A and 16B connected to the rectangular ducts 26A to 26D and an outflow port 16C and an inflow port 16D connected to the heat absorption side heat exchanger 17.

To the connection port 16A, the low temperature side pipes PL11 to PL41 drawn out from the heat pump body 11 are connected. To the connection port 16B, the low temperature side pipes PL12 to PL42 drawn out from the heat pump body 11 are connected. The outflow port 16C is connected to an inlet of the heat absorption side heat exchanger 17 through a pipe 44 and the inflow port 16D is connected to an outlet of the heat absorption side heat exchanger 17 through a pipe 45, so that a circulation path on the heat absorption side is configured.

Then, the low temperature side switching valve 16 is switched to a state of causing the connection port 16A to communicate with the outflow port 16C synchronizing with the rotation of the rotor 21 described above and causing the connection port 16B to communicate with the inflow port 16D and a state of causing the connection port 16A to communicate with the inflow port 16D and causing the connection port 16B to communicate with the outflow port 12C.

The circulating pump 15, the high temperature side switching valve 12, the low temperature side switching valve 16, and the pipes configure a heat medium moving mechanism of reciprocating a heat medium between the high temperature end 29H and the low temperature end 29L of each of the magnetic work body units 26A to 26D.

### [Operation of Magnetic Heat Pump Device 10]

Next, the operation of the magnetic heat pump device 10 having the above-described configuration is described.

First, when the supporting disks 22 and 23 of the heat pump body 11 are located at 0° positions (positions illustrated in FIG. 2), the permanent magnets 24A, 25A and 24B, 25B are located at 0° and 180° positions. Therefore, the magnitude of magnetic fields applied to the magnetic work body units 26A, 26B located at the 0° and 180° positions increases, so that the plate-shaped magnetic work bodies 28 are magnetized and the temperature increases.

On the other side, the magnitude of magnetic fields applied to the magnetic work body units 26C, 26D located at 90° and 270° positions having a phase different therefrom by 90° decreases, so that the plate-shaped magnetic work bodies 28 are demagnetized and the temperature decreases.

When the supporting disks 22 and 23 are located at the 0° positions (FIG. 2), the high temperature side switching valve 12 causes the connection port 12A to communicate with the outflow port 12C and causes the connection port 12B to communicate with the inflow port 12D and the low temperature side switching valve 16 causes the connection port 16A to communicate with the inflow port 16D and causes the connection port 16B to communicate with the outflow port 16C.

By the operation of the circulating pump 15, a heat medium (water) is brought into a state of being circulated as indicated by the solid line arrows in FIG. 1 in the order of the circulating pump 15→the pipe 43→from the inflow port 12D to the connection port 12B of the high temperature side switching valve 12→the high temperature side pipes PH32 and PH42→the magnetic work body units 26C and 26D at the 90° and 270° positions→the low temperature side pipes PL32 and PL42→from the connection port 16B to the outflow port 16C of the low temperature side switching valve 16→the pipe 44→the heat absorption side heat exchanger 17→the pipe 45→from the inflow port 16D to the connection port 16A of the low temperature side switching valve 16→the low temperature pipes PL11 and PL21→the magnetic work body units 26A and 26B at the 0° and 180° positions→the high temperature side pipes PH11 and PH21→from the connection port 12A to the outflow port 12C of the high temperature side switching valve 12→the pipe 41→the heat dissipation side heat exchanger 13→the pipe 42→the heater 14→the circulating pump 15.

The heat medium (water) in the magnetic work body units 26A, 26B vibrates in the axial direction of the magnetic work body units 26A, 26B to transmit the heat from the low temperature end 29L to the high temperature end 29H, the heat medium (water), the temperature of which has become high at the high temperature end 29H, flows out of the high temperature side pipes into the heat dissipation side heat exchanger 13 to release the amount of heat corresponding to the work to the outside (open air and the like), and then the heat medium (water), the temperature of which has become low at the low temperature end 29L, flows out of the low temperature side pipes into the heat absorption side heat exchanger 17 to absorb heat from a body 51 to be cooled to cool the body 51 to be cooled.

More specifically, the heat medium (water) which is cooled by dissipating heat to the magnetic work body units 26C, 26D, the temperature of which has decreased by being demagnetized, absorbs heat from the body 51 to be cooled in the heat absorption side heat exchanger 17 to cool the body 51 to be cooled. Thereafter, the heat medium (water) absorbs heat from the magnetic work body units 26A, 26B, the temperature of which has increased by being magnetized, to cool the same, returns to the heat dissipation side heat exchanger 13, and then releases the amount of heat corresponding to the work to the outside (open air and the like).

Next, when the supporting disks 22 and 23 are rotated by 90° in the counterclockwise direction with the permanent magnets 24A, 25A and 24B, 25B, the magnetic work body units 26A, 26B located at the 0° and 180° positions are demagnetized and the temperature decreases and the magnetic work body units 26C and 26D located at the 90° and 270° positions are magnetized and the temperature increases. At this time, when the high temperature side switching valve 12 and the low temperature side switching valve 16 contain rotary valves, valve bodies thereof are rotated by 90° with the supporting disks 22, 23. Therefore, the heat medium (water) is next brought into a state of being circulated as indicated by the dotted line arrows in FIG. 1 in the order of the circulating pump 15→the pipe 43→from the inflow port 12D to the connection port 12B of the high temperature side switching valve 12→the high temperature side pipes PH12 and PH22→the magnetic work body units 26A and 26B at 0° and 180° positions→the low temperature side pipes PL12 and PL22→from the connection port 16B to the outflow port 16C of the low temperature side switching valve 16→the pipe 44→the heat absorption side heat exchanger 17→the pipe 45→from the inflow port 16D to the connection port 16A of the low temperature side switching valve 16→the low temperature side pipes PL31 and PL41→the magnetic work body units 26C and 26D at the 90° and 270° positions→the high temperature side pipes PH31 and PH41→from the connection port 12A to the outflow port 12C of the high temperature side switching valve 12→the pipe 41→the heat dissipation side heat exchanger 13→the pipe 42→the heater 14→the circulating pump 15.

The rotation of the supporting disks 22 and 23 and the switching of the high temperature side switching valve 12 and the low temperature side switching valve 16 are performed at the number of relatively high speed rotations and relatively high speed timing, the heat medium (water) is reciprocated between the high temperature end 29H and the low temperature end 29L of each of the magnetic work body units 26A to 26D, and the heat absorption/heat dissipation from each of the magnetic work body units 26A to 26D to be magnetized/demagnetized is repeated, whereby a temperature difference between the high temperature end 29H and the low temperature end 29L of each of the magnetic work body units 26A to 26D gradually increases. After a while, the temperature of the low temperature end 29L of each of the magnetic work body units 26A to 26D connected to the heat absorption side heat exchanger 17 decreases to a temperature at which the refrigerating capacities of the magnetic work body units 26A to 26D and the heat load of the body 51 to be cooled are balanced, so that the temperature of the high temperature end 29H of each of the magnetic work body units 26A to 26D connected to the heat dissipation side heat exchanger 13 becomes a substantially constant temperature because the heat dissipation capacity and the refrigerating capacity of the heat dissipation side heat exchanger 13 are balanced.

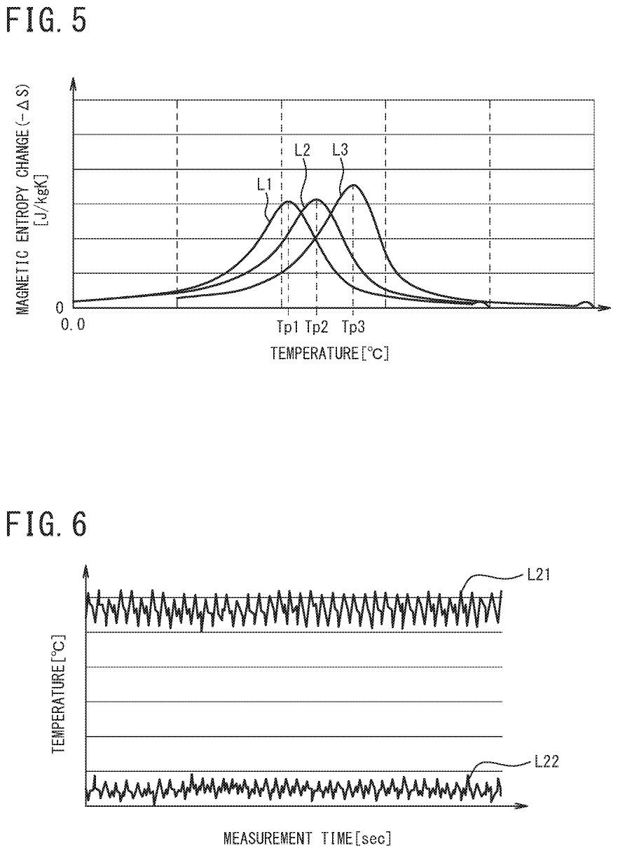

As described above, when the temperature difference between the high temperature end 29H and the low temperature end 29L of each of the magnetic work body units 26A to 26D increases by the repetition of the heat absorption/heat dissipation to reach a temperature difference balanced with the capacity of the magnetic work substances, the temperature change is saturated. Herein, FIG. 6 illustrates the temperatures of the high temperature end 29H and the low temperature end 29L in the state where the temperature change is saturated as described above by L21 and L22. As is clarified also from the figure, both the high temperature end 29H and the low temperature end 29L are affected by the heat absorption and the heat dissipation by the magnetization and the demagnetization and the temperature fluctuates with a predetermined temperature width (about 2 K in Examples).

Both or either one of the heat dissipation side heat exchanger 13 and the heat absorption side heat exchanger 17 contains a microchannel heat exchanger in Examples so that heat can be exchanged with the outside (open air or the body 51 to be cooled) with such a small temperature difference. The microchannel heat exchanger has a higher heat transfer coefficient and also a larger heat transfer area per unit volume as compared with those of heat exchangers of the other types, and thus is very suitable for obtaining required capacities by the magnetic heat pump device 10 as in the present invention.

The heat medium supplied to the high temperature end 29H or the low temperature end 29L of each of the magnetic work body units 26A to 26D flows into the low temperature end 29L side from the high temperature end 29H or into the high temperature end 29H side from the low temperature end 29L through heat medium passages formed of gaps between the laminated plate-shaped magnetic work bodies 28. At this time, since the heat medium passages configured from the gaps are linearly formed in the axial direction, the flow passage resistance is low and the pressure loss decreases.

Moreover, the plate-shaped magnetic work body 28 can be used in the state of the flat plate shape and machining, such as cutting, grinding, and polishing, is not required, and therefore chips are not generated, so that an expensive magnetic work substance can be effectively used.

In order to adjust the gap between the plate-shaped magnetic work bodies 28 of the magnetic work body units 26A to 26D, the inclination angle when inserted into the rectangular ducts 27A to 27D can be changed by adjusting the width of each of the plate-shaped magnetic work bodies 28. The inclination angle approaches the horizontal when the width is narrowed to be close to the inner width of the rectangular ducts 27A to 27D and the inclination angle can be increased in the vertical direction by increasing the width to be larger in a direction of departing from the inner width of the rectangular ducts 27A to 27D.

Thus, according to the first embodiment, by making the width of the plate-shaped magnetic work bodies 28 laminated in the rectangular ducts 27A to 27D larger than the inner width of the rectangular ducts 27A to 27D, the heat medium flow passages with a predetermined gap can be formed only by laminating the plate-shaped magnetic work bodies 28 in the zigzag shape in the rectangular ducts 27A to 27D, so that the magnetic work body units 26A to 26D can be created with ease and at a low cost. Moreover, it is not required to provide a positioning member in the rectangular ducts 27A to 27D, and therefore the rectangular ducts 27A to 27D can be easily created.

Accordingly, the heat pump body 11 containing the magnetic work body units 26A to 26D can be created with ease at a low cost, and further the entire magnetic heat pump device 10 can be created with ease and at a low cost.

The first embodiment describes the case where the rectangular ducts 27A to 27D in which the magnetic work bodies 28 are disposed are provided between the supporting disks 22 and 23 but is not limited thereto and the number of rectangular ducts in which the magnetic work bodies are disposed can be set to an arbitrary number and the number of permanent magnets disposed on the rotor 21 can also be arbitrarily set. In short, the number of magnetic work bodies in a magnetized state and the number of magnetic work bodies in a demagnetized state may be equal to each other.

### Second Embodiment

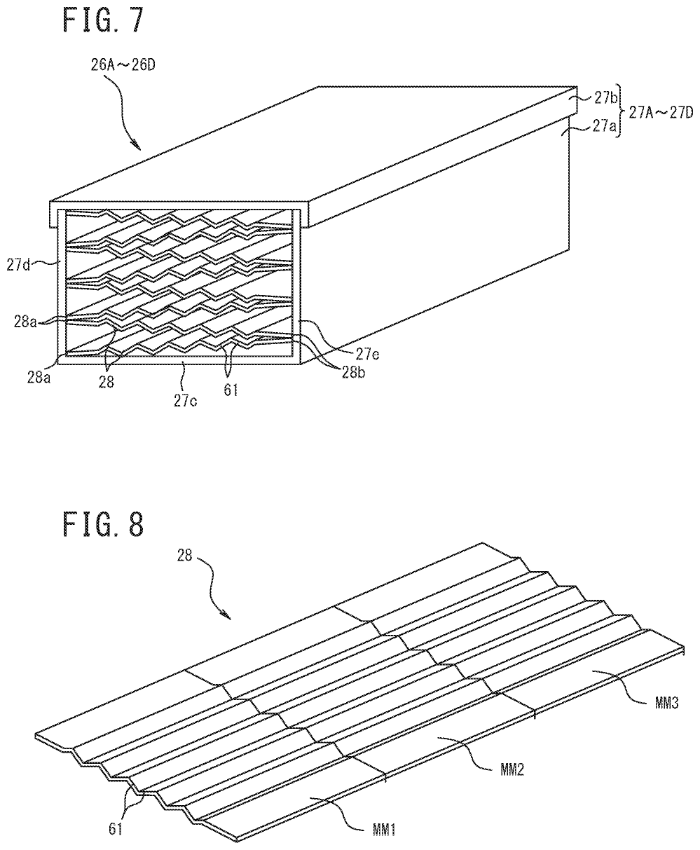

Next, a second embodiment of a magnetic work body according to the present invention is described with reference to FIGS. 7 and 8.

In this second embodiment, the heat transfer area of a plate-shaped magnetic work body is further expanded.

More specifically, the plate-shaped magnetic work body 28 is formed into a shape of having bent portions 61 bent into a triangular wave shape except both end sides in the width direction as illustrated in FIGS. 7 and 8 in place of the flat plate shape in the second embodiment.

As illustrated in FIG. 8, the plate-shaped magnetic work bodies 28 are laminated as they are in the rectangular ducts 27A to 27D in the same manner as in the first embodiment, whereby the magnetic work body units 26A to 26D can be configured in which heat medium flow passages are formed between the laminated plate-shaped magnetic work bodies 28.

The other configurations have the same configurations as those of the first embodiment described above and the corresponding portions are designated by the same reference numerals and a detailed description thereof is omitted.

According to the second embodiment, the plate-shaped magnetic work body 28 has the bent portions 61, and therefore the heat transfer area of the plate-shaped magnetic work body 28 can be expanded and the magnetic work substance amount also increases by the bent portions 61 as compared with those of the first embodiment described above, and therefore the magnetocaloric effect can also be improved.

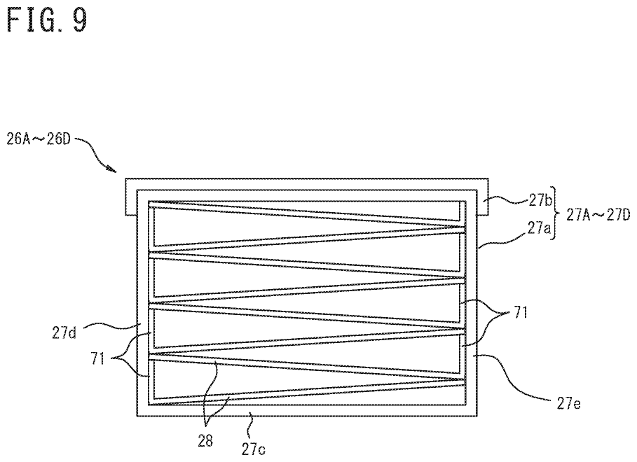

The above-described first and second embodiments describe the case where the plate-shaped magnetic work bodies 28 are laminated in the zigzag shape as viewed in the heat medium flowing direction but are not limited thereto. It is preferable to bend and form interval regulation pieces 71 along the left side surface plate 27d or the right side surface plate 27e of the rectangular ducts 27A to 27D on one end in the width direction of the plate-shaped magnetic work bodies 28 as illustrated in FIG. 9. In this case, the plate-shaped magnetic work bodies 28 are alternately laminated to bring the upper end of the interval regulation piece 71 of one plate-shaped magnetic work body 28 into contact with an end portion opposite to the interval regulation piece 71 of the other plate-shaped magnetic work body 28, whereby the interval adjustment between the plate-shaped magnetic work bodies 28 can be accurately performed, so that heat medium flow passages having a uniform cross-sectional area can be formed. Moreover, the error in the width direction of the plate-shaped magnetic work bodies 28 can be permitted within the thickness range.

The above-described first and second embodiments describe the case where the plate-shaped magnetic work bodies 28 are laminated in the zigzag shape between the right and left side surface plates 27d and 27e in the rectangular ducts 27A to 27D but are not limited thereto and the plate-shaped magnetic work bodies 28 may be laminated in the zigzag shape between the upper surface plate and the lower surface plate of the rectangular ducts 27A to 27D.

Moreover, the above-described first and second embodiments describe the case where the plate-shaped magnetic work body 28 contains the three magnetic work substances different in the temperature zone where a high magnetocaloric effect is exhibited but are not limited thereto and the plate-shaped magnetic work body 28 may contain four or more magnetic work substances.

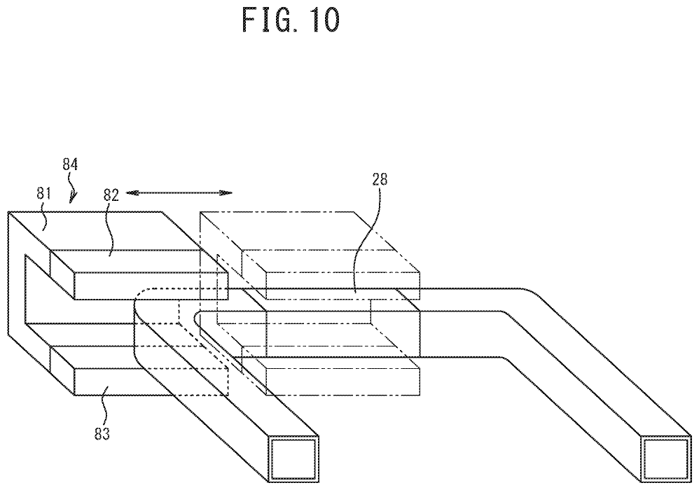

Moreover, the above-described first and second embodiments describe the case where the magnetic heat pump device is formed so that the permanent magnets are rotated but are not limited thereto. For example, as illustrated in FIG. 10, the heat pump body 11 may be configured so that a direct-acting body 84 in which permanent magnets 82 and 83 are individually disposed facing each other on the open end side of a magnetic yoke 81 having a horizontal U-shaped cross-section and a magnetic work body unit 26 in which the plate-shaped rectangular parallelepiped-shaped magnetic work bodies 28 are laminated in a zigzag shape are disposed to be relatively movable. In this case, it is configured so that the direct-acting body 84 is made movable in a direction orthogonal to the permanent magnets 82 and 83 by a direct-acting mechanism utilizing a linear motor, a ball screw mechanism, and a motor and the rectangular parallelepiped-shaped magnetic work body unit 26 is disposed between the movement tracks of the permanent magnets 82 and 83 in the middle of the movement path. Then, the direct-acting body 84 is reciprocated, whereby magnetization and demagnetization of the plate-shaped magnetic work bodies 28 of the magnetic work body unit 26 can be repeatedly performed. On the contrary, the magnetic work body unit 26 may be reciprocated.

Furthermore, the heat pump body 11 may contain a fixed and disposed stator and a rotor rotating facing the stator, a permanent magnet may be disposed on the surface facing the stator of the rotor, an arc-shaped magnetic work body unit may be disposed on the surface facing the permanent magnet of the stator, and the plate-shaped magnetic work bodies 28 may be disposed in a zig zag shape in the magnetic work body unit.

### REFERENCE SIGNS LIST

10 magnetic heat pump device
11 heat pump body
12 high temperature side switching valve
13 heat dissipation side heat exchanger
14 heater
15 circulating pump
16 low temperature side switching valve
17 heat absorption side heat exchanger
21 rotation shaft
22, 23 supporting disk
24A, 24B, 25A, 25B permanent magnet
26, 26A to 26D magnetic work body unit
27A to 27D rectangular duct
27a bottomed square tubular portion
27b lid portion
28 plate-shaped magnetic work body
61 bent portion
71 interval regulation piece
81 magnetic yoke
82, 83 permanent magnet
84 direct-acting body

1. A magnetic work body unit comprising:
a plurality of plate-shaped magnetic work bodies laminated in a zigzag shape as viewed in a flowing direction of a heat medium between facing inner surfaces of a rectangular duct forming a flow passage through which the heat medium passes.

2. The magnetic work body unit according to claim 1,
wherein the plate-shaped magnetic work body has a wavelike bent portion extending in the flowing direction of the heat medium.

3. The magnetic work body unit according to claim 1,
wherein an interval regulation piece is bent and formed on a side of one end contacting either one of the facing inner surfaces of the rectangular duct in the plate-shaped magnetic work body.

4. A magnetic heat pump device comprising:
the magnetic work body unit according to claim 1 in which a heat medium is made to flow;
a magnetic field changing mechanism configured to change a magnitude of a magnetic field applied to a magnetic work body of the magnetic work body unit;
a heat medium moving mechanism configured to move the heat medium between a high temperature end and a low temperature end of the magnetic work body unit;
a heat dissipation side heat exchanger configured to cause the heat medium on a side of the high temperature end to dissipate heat; and
a heat absorption side heat exchanger configured to cause the heat medium on a side of the low temperature end to absorb heat.

5. The magnetic work body unit according to claim 2,
wherein an interval regulation piece is bent and formed on a side of one end contacting either one of the facing inner surfaces of the rectangular duct in the plate-shaped magnetic work body.

6. A magnetic heat pump device comprising:
the magnetic work body unit according to claim 2 in which a heat medium is made to flow;
a magnetic field changing mechanism configured to change a magnitude of a magnetic field applied to a magnetic work body of the magnetic work body unit;
a heat medium moving mechanism configured to move the heat medium between a high temperature end and a low temperature end of the magnetic work body unit;
a heat dissipation side heat exchanger configured to cause the heat medium on a side of the high temperature end to dissipate heat; and
a heat absorption side heat exchanger configured to cause the heat medium on a side of the low temperature end to absorb heat.
